(19) United States
(12) Patent Application Publication
(10) Pub. No.: US 2003/0086832 A1
(43) Pub. Date: May 8, 2003

(54) End cones for exhaust emission control devices and methods of making

(76) Inventor: Alan G. Turek, Mayville, MI (US)

Correspondence Address: VINCENT A. CICHOSZ, ESQ., DELPHI TECHNOLOGIES, INC., P.O. Box 5052, Mail Code: 480-414-420, Troy, MI, 48007-5052, US

(21) Appl. No.: 10/000,207

(22) Filed: Nov. 2, 2001

(51) Int. Cl. B01D 53/94; F01N 3/28; F01N 7/14

(52) U.S. Cl. 422/179; 422/171; 422/177; 29/890

(57) ABSTRACT

An end cone for an exhaust emission control device is provided. The end cone comprises an outer shell and an end cone insulator. The outer shell has an inner surface. The end cone insulator comprises insulation and binder defining a passage therethrough. The end cone insulator has a first surface being disposed adjacent to the inner surface, and a second surface, at least a portion of which is exposed to the passage.

### BACKGROUND

This disclosure relates to exhaust emission control devices. More particularly, this disclosure relates to end cones for exhaust emission control devices.

The removal of emissions, such as hydrocarbon, carbon monoxide, nitrogen oxide, particulate matter, and the like, from the exhaust gases of internal combustion engines is required for cleaner operating vehicles. One focus area for such exhaust emission reduction has been in the area of post combustion treatment. Namely, post combustion treatment includes the placement of one or more exhaust emission control devices in the exhaust down stream of the internal combustion engine. Such exhaust emission control devices include catalytic converters, catalytic absorbers, diesel particulate traps, non-thermal plasma conversion devices, and the like.

Many exhaust emission control devices often include fragile structures prone to crushing and damage in the exhaust environment. For example, exhaust emission control devices have used a substrate or monolith, commonly made of fireproof ceramic (e.g., cordierite, carbon, and the like). The substrate includes a cellular structure to provide a high surface area for exposure to the exhaust gas.

The substrate is often retained in the exhaust pipe housing by means of a retention material or mat. The retention material is adapted to retain the substrate in housing and to seal the gap between the substrate and the housing to force the exhaust gas through the cellular structure of the substrate.

### SUMMARY

An end cone for an exhaust emission control device is provided. The end cone comprises an outer shell and an end cone insulator. The outer shell has an inner surface. The end cone insulator comprises insulation and binder defining a passage therethrough. The end cone insulator has a first surface being disposed adjacent to the inner surface, and a second surface, at least a portion of which is exposed to the passage.

A method of manufacturing an end cone is provided. The method comprises forming an outer shell, forming an end cone insulator, and disposing the end cone insulator in the outer shell. The outer shell has an inside surface. The end cone insulator comprises binder and insulation. The end cone insulator has an inboard end, an outboard end, a first surface, and a second surface. The end cone insulator is disposed in the outer shell such that the inside surface and the first surface are adjacent, and such that at least a portion of the second surface is exposed.

An exhaust emission control device is provided. The device comprises a substrate, a housing, a retention material, a pair of outer shells, and a pair of insulators. The housing has an inlet end and an outlet end. The retention material supports the substrate in the housing between the inlet end and the outlet end. One of the outer shells is disposed on the inlet end, and a second one of the outer shells is disposed on the outlet end. The insulators are comprised of insulation and binder. The insulators have a first surface disposed adjacent to an inner surface of the outer shell. Each of the insulators is connected at least at an outboard end to the outer shells, and each of the insulators is supported at an inboard end by the substrate and the retention material.

A method of manufacturing an exhaust emission control device is provided. The method comprises forming insulators from binder and insulation, and supporting a substrate in a housing with a retention material. The insulators have an inboard end, an outboard end, a first surface, and a second surface opposite the first surface. The housing has an inlet end and an outlet end. The method further comprises placing a first one of the insulators at the inlet end such that its inboard end is supported by the substrate and the retention material, and placing a second one of the insulators at the outlet end such that its inboard end is supported by the substrate and the retention material.

The above-described and other features are appreciated and understood by those skilled in the art from the following detailed description, drawings, and appended claims.

### BRIEF DESCRIPTION OF THE DRAWINGS

Referring now to the Figures, where like elements are numbered alike:

FIG. 1 is a partially cut-away perspective view of an exhaust emission control device;

FIG. 2 is a cross sectional view of the exhaust emission control device of FIG. 1, taken along lines 2-2;

FIG. 3 is an exploded perspective view of an exhaust emission control device having end cones;

FIG. 4 is a cross-sectional view of the device of FIG. 3 taken in a direction perpendicular to the longitudinal axis of the device;

FIG. 5 is a sectional view of the device of FIG. 3 illustrating an exemplary embodiment of an end cone insulator;

FIG. 6 is a sectional view of the device of FIG. 3 illustrating an alternate exemplary embodiment of an end cone insulator;

FIG. 7 is a sectional view of the device of FIG. 3 illustrating another exemplary embodiment of an end cone insulator;

FIG. 8 is a sectional view of the device of FIG. 3 also illustrating an exemplary embodiment of an end cone insulator; and

FIG. 9 is a sectional view of an alternate embodiment of a housing using the end cone insulator of FIG. 8.

### DESCRIPTION OF THE PREFERRED EMBODIMENT

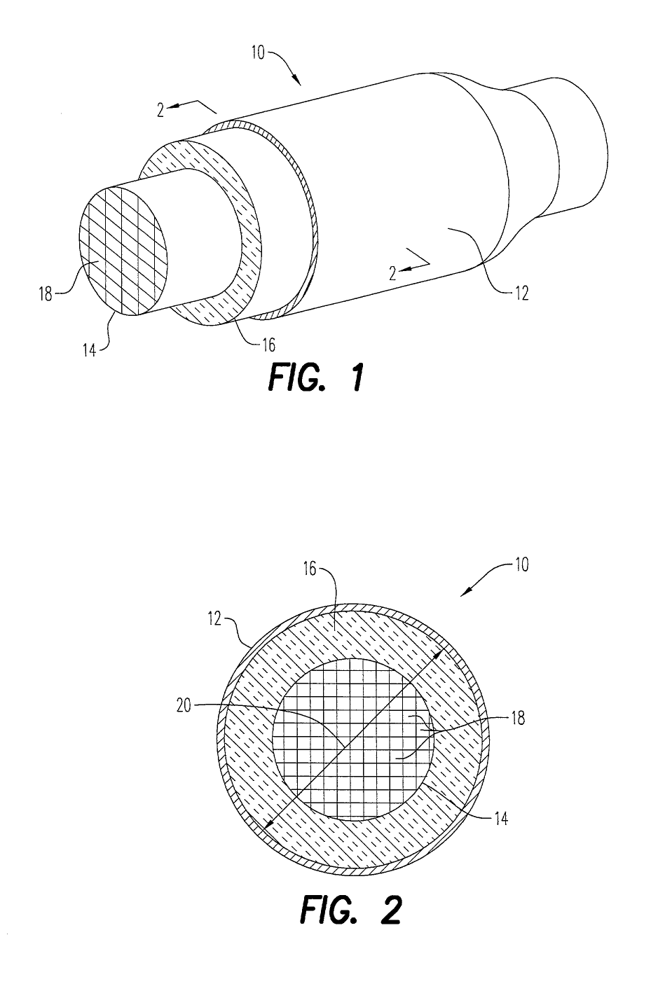

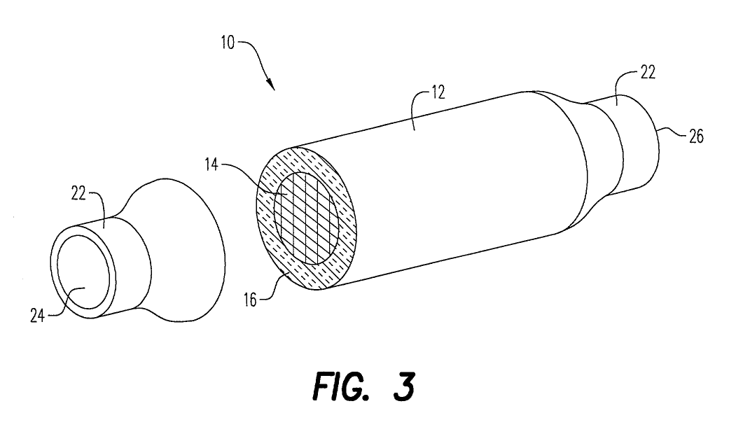

Referring now to FIGS. 1-3, an exhaust emission control device 10 is illustrated. Exhaust emission control device 10 includes an outer housing 12, a substrate 14, and a retention material 16. Disposed at both ends of the device 10, i.e., an inlet end 24 and at an outlet end 26, are end-cones 22 connectable in fluid communication with an exhaust gas stream of an internal combustion engine. By way of example, device 10 is a catalytic converter, a catalytic absorber, a diesel particulate trap, a non-thermal plasma conversion device, and the like. Accordingly, by way of example, substrate 14 is a catalytic converting substrate, a catalytic absorbing substrate, a diesel particulate trapping substrate, a non-thermal plasma converting substrate, and the like.

Retention material 16, which is concentrically disposed around the substrate 14, comprises either be an intumescent material, e.g., one which comprises ceramic materials, and other materials such as organic binders and the like, or combinations comprising at least one of the foregoing materials, and a vermiculite component that expands with heating to maintain firm uniform compression, or non-uniform compression, if desired; or a non-intumescent material, e.g., one that does not contain vermiculite; as well as materials which include a combination of both intumescent and non-intumescent materials. Non-intumescent materials include materials such as 900HT, 1100HT, and those sold under the trademarks “NEXTEL” and “SAFFIL” by the “3M” Company, Minneapolis, Minn. or those sold under the trademark, “FIBERFRAX” and “CC-MAX” by the Unifrax Co., Niagara Falls, N.Y., and the like. Intumescent materials include materials, sold under the trademark “INTERAM” by the “3M” Company, Minneapolis, Minn., such as INTERAM 100, as well as those intumescents which are also sold under the aforementioned “FIBERFRAX” trademark by the Unifrax Co., Niagara Falls, N.Y. as well as combinations comprising at least one of the foregoing materials, and others.

In use, exhaust emission control device 10 is subjected to a large range of temperatures and vibrations. Accordingly, the retention pressure placed on substrate 14 by retention material 16 is sufficient to successfully hold the substrate and insulate it from shock and vibration. The retention material 16 should further form a barrier between the substrate and the interior of the housing 12 by substantially filling the space there between, thereby ensuring that the exhaust gas passes through cells 18 of the substrate.

For example, when the exhaust emission control device 10 is placed in the exhaust stream after the internal combustion engine of a vehicle (not shown), exhaust gas passes through cells 18 of substrate 14. The substrate 14 itself and/or active materials thereon reduce, convert, and/or eliminate one or more emissions from the exhaust stream.

Substrate 14 comprises any material designed for use in a spark ignition or diesel engine environment and having the following characteristics: (1) capable of operating at temperatures up to about 1,000° C.; (2) capable of withstanding exposure to hydrocarbons, nitrogen oxides, carbon monoxide, carbon dioxide, and/or sulfur; and if a catalyst is employed, (3) having sufficient surface area and structural integrity to support the desired emission acting components (e.g., catalyst materials). Some possible materials for substrate 14 include, but are not limited to, cordierite, silicon carbide, metallic foils, alumina sponges, porous glasses, and the like, and mixtures comprising at least one of the foregoing materials. Some ceramic materials include “Honey Ceram”, commercially available from NGK-Locke, Inc, Southfield, Mich., and “Celcor”, commercially available from Corning, Inc., Corning, N.Y.

The size and geometry of substrate 14 are chosen to optimize surface area of cells 18 in the given design parameters of exhaust emission control device 10. Typically, substrate 14 has a honeycomb geometry. Cells 18 are contemplated as having any polygonal or rounded shape, with substantially square, triangular, pentagonal, hexagonal, heptagonal, or octagonal, or similar geometries, as well as combinations comprising at least one of these geometries, preferred, due to ease of manufacturing and increased surface area.

Depending upon the type of the emission control device 10, disposed on and/or throughout the substrate 14 may be a catalyst for converting one or more exhaust gasses (e.g., hydrocarbons, carbon monoxide, sulfur, nitrogen oxides, and the like) to acceptable emissions levels. The catalyst comprises one or more catalyst materials that are wash coated, imbibed, impregnated, physisorbed, chemisorbed, precipitated, or otherwise applied to substrate 14. Possible catalyst materials include metals, such as platinum, palladium, rhodium, iridium, osmium, ruthenium, tantalum, zirconium, yttrium, cerium, nickel, copper, and the like, as well as oxides, alloys, and combinations comprising at least one of the foregoing catalyst materials, and other catalysts.

The choice of material for housing 12 and/or end cones 22 depends upon the type of exhaust gas, the maximum temperature reached by device 10, the maximum temperature of the exhaust gas stream, and the like. Suitable materials include any material that is capable of resisting under-car salt, temperature, and corrosion. Typically, ferrous materials are employed such as ferritic stainless steels. Ferritic stainless steels include stainless steels such as, e.g., the 400—Series such as SS-409, SS-439, and SS-441, with grade SS-409 generally preferred.

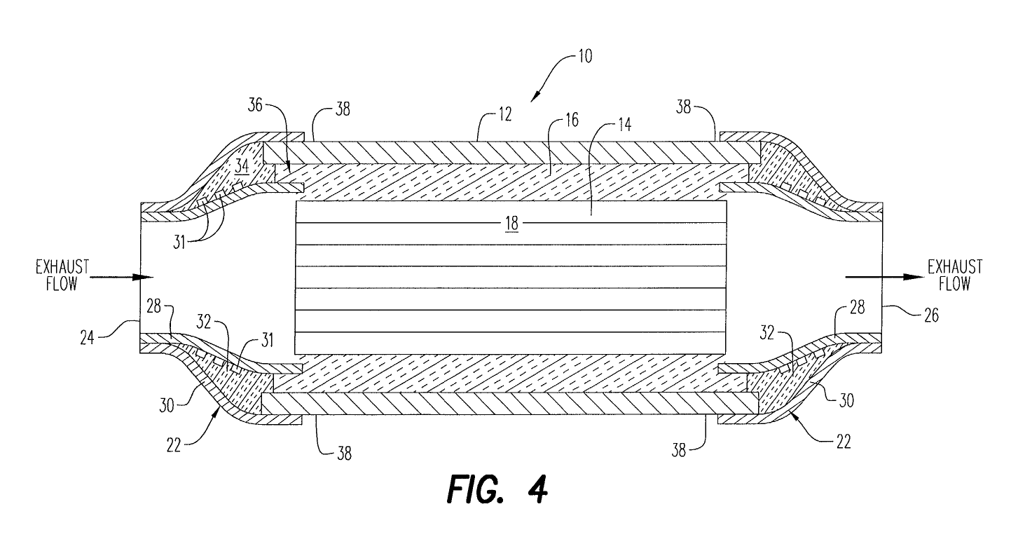

As illustrated in FIG. 4, each end cone 22 includes an inner shell 28, an outer shell 30, and a layer of insulation 32. Inner shell 28 and outer shell 30 are joined to each other remote from housing 12. Namely, inner shell 28 and outer shell 30 are joined at one end, and are configured to diverge from each other as the distance from the joined end increases, thereby forming a gap 36 at the opposing or second end. Thus, shells 28 and 30 define an open area 34 therebetween, and gap 36 for receiving an end of housing 12.

Outer shell 30 has an inner surface connected to an outer surface 38 of housing 12 such that inner shell 28 is between substrate 14 and the housing. In this manner, inner shell 28 is configured to direct the exhaust gas through substrate 14. Accordingly, the second end of inner shell 28 is preferably positioned proximate substrate 14. Inner shell 28 therefore also directs the exhaust gas away from retention material 16 and insulation 32 to protect the retention material and the insulation from erosion due to exposure to the exhaust gas.

Preferably, the second end of inner shell 28 extends into retention material 16. The distance of the extension is preferably sufficient to direct the exhaust gas into substrate 14. For example, an extension of less than or equal about 4 millimeters are employed, with an extension of greater than or equal to about 2 mm preferred. In the region where the inner shell 28 extends into the retention material 16, the compression of retention material 16 is increased, which makes retention material 16 less porous at the inlet of substrate 14 further aiding in the direction of the exhaust gas into the substrate. Disposed between the inner shell 28 and the outer shell 30 is a layer of insulation 32. The insulation 32 comprises a plurality of relief area or notches 31 to allow the insulation to conform to the curve of shells 28 and 30. The formation of notches 31 adds expense and time to the manufacture of end cones 22. Insulation 32 reduces heat loss from the exhaust gas and reduces radiated sound from device 10. For example, in the instance where substrate 14 comprises a catalyst, insulation 32 ensures that the catalyst reaches its “light-off” or activated temperature quickly during cold start-ups of the engine. Insulation 32 also aids in reducing the temperature of outer shell 30, which is useful for thermal management of the vehicle.

However, inner shell 28 adds to the thermal mass of end cone 22, which frustrates the effects of insulation 32 and leads to an increase in the end cone's conduction of heat to outer shell 30. Further, when device 10 reaches its operating temperature inner shell 28 is exposed a higher temperature than is outer shell 30. Thus, in instances where inner and outer shells 28 and 30 have a similar coefficient of thermal expansion, the inner shell expands more than the outer shell, which decreases open area 36 and compresses insulation 32. Compression of insulation 32 reduces its insulatory effects, which further increases the end cone's conduction of heat to outer shell 30.

The formation of inner shell 28 also requires costly and time-consuming progressive die or die set operations. Thus, inner shell 28 increases the cost of end cone 22, decreases the end cone's ability to maintain a desired temperature of outer shell 30 and/or substrate 14, and increases damage to the substrate in the areas of increased compression of retention material 16.

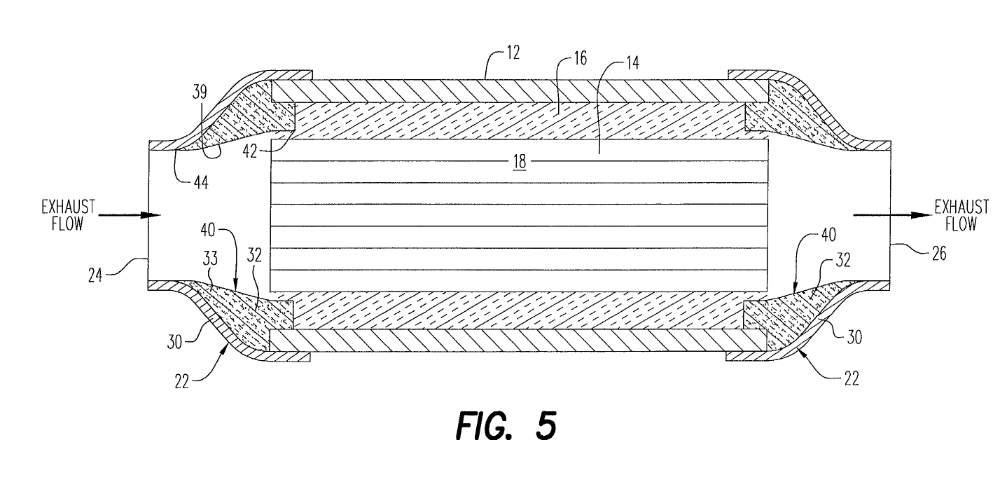

Referring now to FIGS. 5-8, exemplary embodiments of end cone insulators are illustrated. An exemplary embodiment of an end cone insulator 40 is illustrated in FIG. 5. End cone 22 includes an outer shell 30 and end cone insulator 40. End cone insulator 40 comprises a layer of insulation 32 impregnated, dispersed, and/or mixed with a binder 33. Insulation 32, impregnated with binder 33, provides insulator 40 with a semi-rigid configuration.

More specifically, end cone insulator 40 replaces the inner shell 28. Here, end cone insulator 40 has a shape that conforms to the interior shape of the outer shell 30. Binder, or similar material, 33 enables molding or otherwise forming of insulation 32 into the desired shape and provides the insulator with the desired structural integrity.

Preferably, end cone insulator 40 extends into retention material 16. The distance of the extension is preferably sufficient to direct the exhaust gas into substrate 14. For example, an extension of less than or equal about 4 millimeters are employed, with an extension of greater than or equal to about 2 mm preferred. In the region where end cone insulator 40 extends into the retention material 16, the compression of the retention material is increased, which makes the retention material less porous at the inlet of substrate 14 further aiding in the direction of the exhaust gas into the substrate.

Accordingly, insulator 40 is configured to reduce heat loss from the exhaust gas, to reduce radiated sound from device 10, to direct the exhaust gas through substrate 14, and to direct the exhaust gas away from retention material 16.

Insulation 32 and binder 33 are selected from materials capable of withstanding the exhaust gas environment. For example, in one embodiment, insulation 32 is a vermiculite or ceramic fiber based material similar to that of retention material 16, while binder 33 is an inorganic binding material. Of course, other insulations and binders that provide end cone insulator 40 with the desired structural stability and are capable of withstanding the exhaust environment are contemplated.

During assembly, end cone insulator 40 is either preformed and placed in outer shell 30 or is formed directly in outer shell 30. Outer shell 30 with end cone insulator 40 is then connected to outer surface 38 of housing 12. Here, an inboard end 42 of end cone insulator 40 is supported by substrate 14 and retention material 16, while an outboard end 44 of the end cone insulator is connected to outer shell 30. Outboard end 44 is connected to, secured to, and/or held against (hereinafter “connected”) outer shell 30 by, for example, an adhesive, a binder, by mechanical means, by radial forces (e.g., due to the size and geometry of the insulator 40 in relation to the outer shell 30), by the cooperation of the shape of the shell/insulator, and the like, as well as combinations comprising at least one of the foregoing.

End cone insulator 40 provides many benefits through the elimination of the inner shell. For example, eliminating the inner shell removes the costly and time-consuming operations necessary to form it. Eliminating the inner shell also reduces the thermal mass of end cone 22, and thus, decreases the end cone's conduction of heat to outer shell 30. Further, eliminating the inner shell eliminates the compression of the insulation 32 from differences in thermal expansion of the outer and inner shells. Thus, end cone insulator 40 further reduces conduction of heat to outer shell 30, which increases the performance of device 10.

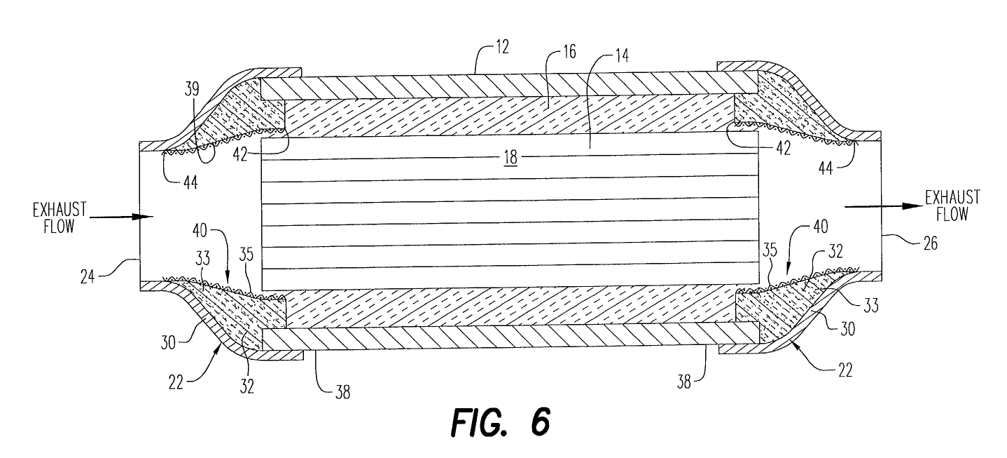

Referring now to FIG. 6, an alternate exemplary embodiment of an end cone insulator 40 is illustrated. Here, end cone 22 includes outer shell 30 and end cone insulator 40. In this embodiment, end cone insulator 40 includes not only binder 33 disposed in insulation 32, but also includes a mesh or screen 35.

Mesh 35 disposed on the surface 39 of insulator 40 exposed to the exhaust gas (i.e., the surface of insulator 40 that is opposite the side of the insulator in contact with outer shell 30). The mesh or screen 35 prevents eroded insulator 40 particles from breaking loose, passing into, and/or fouling cells 18 of the substrate 14. That is, as the density of cells 18 of substrate 14 increases (see FIG. 1), the cross sectional size of the cells decreases. This decrease in size increases the likelihood of blockage or fouling of cells 18 by particulate matter, which reduces the useful life of device 10. The mesh 35 inhibits particulate matter from insulator 40 from entering substrate 14. Since the inlet 24 is upstream of cells 18, the inclusion of end cone insulator 40 having mesh 35 at least at the inlet is desired.

In an alternate embodiment, at outlet 26 (e.g. downstream of cells 18) does not include mesh 35. In this embodiment, the use of the mesh 35 at outlet 35 is optional since it is not necessary to prevent fouling of cells 18. Thus, in this embodiment device 10 has end cone insulator 40 at inlet 24 with mesh 35, but has an end cone insulator at outlet 26 without the mesh.

Mesh 35 includes one or several layers of woven or non-woven fibers, strands, or the like, (e.g., screen(s), blanket(s), and the like) with a sufficient amount of layers to attain the desired particulate retention preferred. Mesh 35 comprises a material capable of withstanding the exhaust gas environment. Some possible materials include those employed for the housing 12, with stainless steel typically preferred.

The use of mesh 35 to add structure and rigidity to insulator 40 is also contemplated. In this embodiment, mesh 35 comprises a sufficient amount of layers or layer thickness to impart the desired structural integrity to insulator 40.

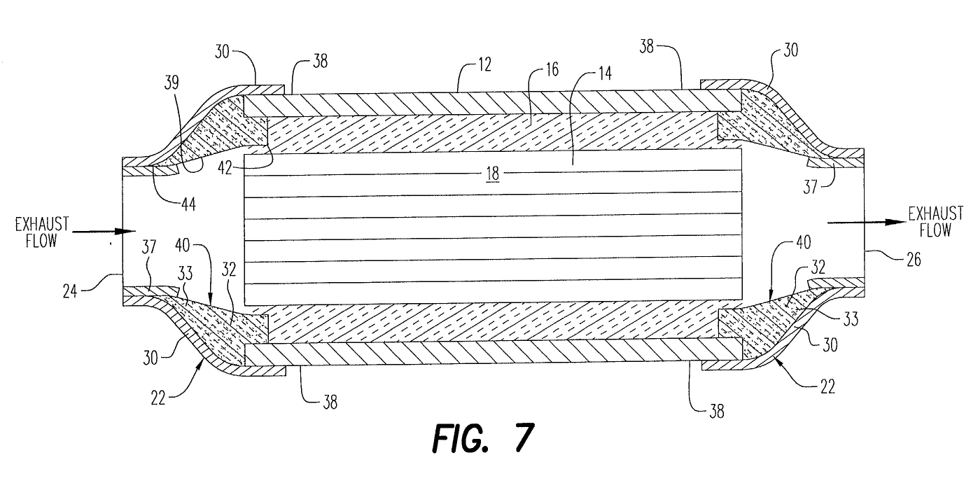

Referring now to FIG. 7, another alternate exemplary embodiment of an end cone insulator 40 is illustrated. Again, end cone 22 includes outer shell 30 and end cone insulator 40. In this embodiment, end cone insulator 40 includes insulation 32 and binder 33, and further includes an inner core or tube 37. Core 37 and outer shell 30 are joined remote from housing 12. As shown, core 37 terminates before substrate 14. Thus, core 37 does not have the thermal mass described above with respect to the inner shell 28. (see FIG. 4) Core 37 is joined to outer shell 30 by, for example, welding, dimpling, bonding, and the like.

Here, inboard end 42 of end cone insulator 40 is supported by substrate 14 and retention material 16, while outboard end 44 of the end cone insulator 40 is disposed between at least a portion of core 37 and outer shell 30. In this configuration, thus core 37 supplements and/or eliminates the joining (mechanical, binder, and the like) of outer shell 30 and end cone insulator 40. Preferably, the core 37 extends a sufficient distance from the inlet 24 to the inlet end of the retention material 16 to provide retention of the insulator, while not undesirably increasing the thermal mass of insulator 40.

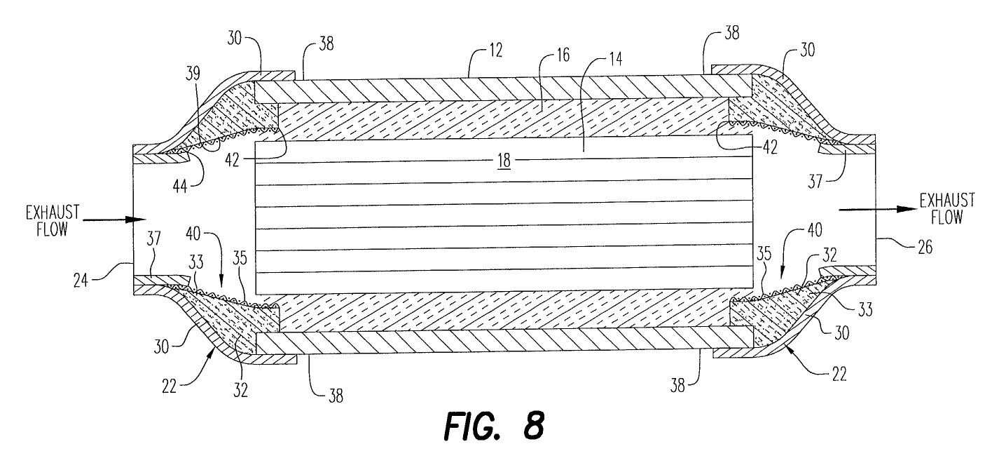

Referring now to FIG. 8, another alternate exemplary embodiment of an end cone insulator 40 is illustrated. Again, end cone 22 includes outer shell 30 and end cone insulator 40. In this embodiment, end cone insulator 40 includes insulation 32, binder 33, screen 35, and inner core or tube 37.

It should be recognized that housing 12 is provided above with respect to FIGS. 5-8 by way of example only as including identical end cones insulators 40 at inlet end 24 and outlet end 26. Of course, ends cone insulators having different features and construction at inlet end 24 than at outlet end 26 are contemplated.

Housing 12 is also discussed above with respect to FIGS. 5-8 is described as a unitary housing, requiring the attachment of separate end cones 22. However, the configuration of the housing is often dependant on the method by which substrate 14 wrapped with retention material 16 is inserted into the housing. For example, in the embodiments discussed above, substrate 14 wrapped with retention material 16 is inserted into housing 12 through one of the open ends of the housing before end cone 22 is connected to the housing. This method is commonly referred to as the “stuffing method”. Of course, other housing designs (e.g., sheet of material, two halves of material, and the like) and other methods (e.g., clam shell, wrapping, and the like) exist, and are contemplated, for the housing and for inserting substrate 14 wrapped with retention material 16 into the housing, respectively.

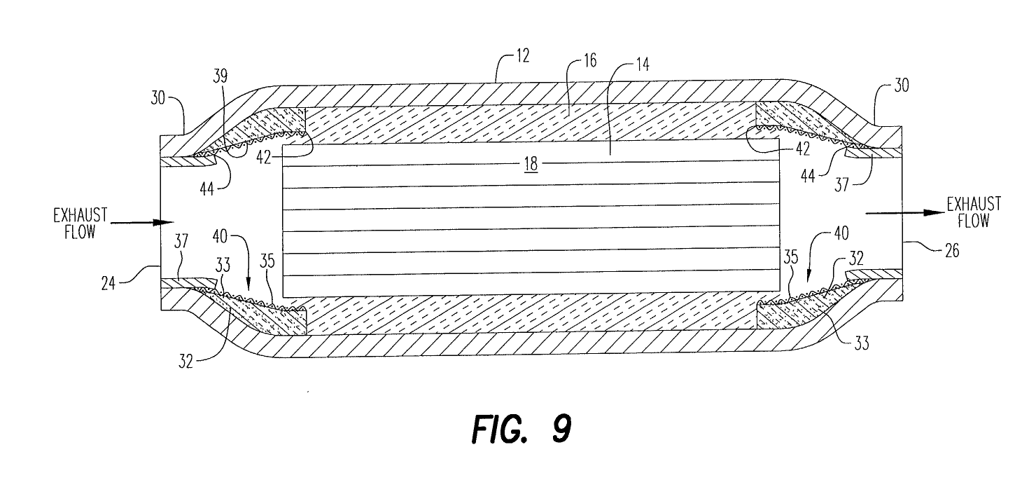

Other methods include other stuffing methods, the clamshell method, the tourniquet method, and the like. For example, another version of the “stuffing method” is referred to as the “stuffing and resizing method”. Here, substrate 14 wrapped with retention material 16 is inserted into housing 12 through one of the open ends of the housing. Next, one or more portions of housing 12 is resized or compressed. Furthermore, one or both of the ends of housing 12 is resized to provide outer shell 30, e.g., via spin-forming and the like. Another commonly used method is referred to as the “clamshell method”. Here, substrate 14 wrapped with retention material 16 is placed between two longitudinal halves or clamshells of housing 12, which includes outer shell 30 integrated thereon. Here, the two halves of housing 12 are closed around the assembly and welded together. Similarly, with the tourniquet method, the substrate 14, wrapped with retention material 16, is inserted into housing 12, which is open on one longitudinal edge and which includes outer shell 30 integrated thereon. Here, housing 12 is closed around the assembly and the open longitudinal edge is then welded closed. Referring now to FIG. 9, and as provided above, it is known to provide outer shell 30 formed as part of housing 12.

In this example, housing 12 is shown having an end cone insulator 40, which includes both screen 35 and inner core or tube 37 as described above.

During assembly with the “stuffing and resizing method” for example, substrate 14, wrapped with retention material 16, is inserted into housing 12 through one of the open ends of the housing. End cone insulators 40 are disposed in operable communication with substrate 14 such that inboard ends 42 of the end cone insulators are supported by the substrate and retention material 16. End cone insulators 40 are disposed around substrate 14 either before or after insertion into housing 12. The ends of housing 12 are then resized around end cone insulators 40 to provide outer shell 30. For example, housing 12 is resized by spin forming, ram forming, magnetic impulse, and the like. Core 37 is optionally secured to outer shell 30 by, for example, welding, bonding, dimpling, compression of the outer shell on the core, and the like.

During assembly with the “clamshell method” for example, substrate 14 is wrapped with retention material 16. End cone insulators 40 are disposed in operable communication with substrate 14 (e.g., around at least an end of substrate 14) such that inboard ends 42 of the end cone insulators are supported by the substrate and retention material 16. End cone insulators 40 are disposed around substrate 14 either before or after placing the substrate between two longitudinal halves or clamshells of housing 12. Here, housing 12 preferably comprises integral outer shells 30. The two halves of housing 12 are closed around the assembly and welded together. Core 37 is optionally secured to outer shell 30 by, for example, welding, bonding, dimpling, and the like.

During assembly with the “tourniquet method” for example, substrate 14 is wrapped with retention material 16. End cone insulators 40 are disposed in operable communication with substrate 14 such that inboard ends 42 of the end cone insulators are supported by the substrate and retention material 16. End cone insulators 40 are disposed around substrate 14 either before or after inserting the substrate into housing 12 through the open longitudinal edge. Housing 12 is closed around the assembly (retention material, substrate, and insulator(s)) and the open longitudinal edge is then welded closed. Core 37 is optionally secured to outer shell 30 either before or after the outer shells are applied to housing 12.

It should be recognized that housing 12 is illustrated by way of example only as including end cone insulator 40 having both screen 35 and inner core or tube 37. Of course, the use of end cones insulators with or without one or both of screen 35 and core 37 with housings having integrated end cones are contemplated. Accordingly and as described above by way of exemplary embodiments, the end cone insulators are configured for use with housings of different designs, with various methods of inserting the substrate into the housing, and with various types of substrates.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An end cone for an exhaust emission control device, comprising:
an outer shell having an inner surface; and
an end cone insulator comprising insulation and binder defining a passage therethrough, said end cone insulator having a first surface being disposed adjacent to said inner surface and a second surface, at least a portion of said second surface being exposed to said passage.

2. The end cone of claim 1, wherein at least a portion of said first surface of said end cone insulator is connected to said inner surface of said outer shell.

3. The end cone of claim 1, wherein said end cone insulator further comprises:
a core having a first side and a second side, said first side for supporting a portion of said second surface, and said second side being connected to said outer shell.

4. The end cone of claim 3, wherein said end cone insulator further comprises a mesh forming said second surface.

5. The end cone of claim 1, wherein said end cone insulator further comprises a mesh forming said second surface.

6. A method of manufacturing an end cone, comprising:
forming an outer shell, said outer shell having an inside surface;
forming an end cone insulator comprising binder and insulation, said end cone insulator having an inboard end, an outboard end, a first surface, and a second surface; and
disposing said end cone insulator in said outer shell such that said inside surface and said first surface are adjacent, and such that at least a portion of said second surface is exposed.

7. The method of claim 6, further comprising:
connecting a first end of a core to said outer shell, and connecting a second end of said core to said end cone insulator.

8. The method of claim 7, further comprising forming said second surface of a mesh.

9. The method of claim 6, further comprising forming said second surface of a mesh.

10. An exhaust emission control device, comprising:
a substrate;
a housing having an inlet end and an outlet end;
a retention material supporting said substrate in said housing between said inlet end and said outlet end;
a pair of outer shells, one of said outer shells being disposed on said inlet end, and a second one of said outer shells being disposed on said outlet end; and
a pair of insulators comprised of insulation and binder, said insulators having a first surface disposed adjacent to an inner surface of said outer shell, each of said insulators being connected at least at an outboard end to said outer shells, and each of said insulators being supported at an inboard end by said substrate and said retention material.

11. The exhaust emission control device of claim 10, wherein said substrate is selected from the group consisting of a catalytic converting substrate, a catalytic absorbing substrate, a diesel particulate trapping substrate, and a non-thermal plasma converting substrate.

12. The exhaust emission control device of claim 10, wherein said insulators each further comprise a core, said core connecting said outboard end to said outer shells.

13. The exhaust emission control device of claim 12, wherein at least said insulator at said inlet end further comprises a mesh forming a second surface of said insulator.

14. The exhaust emission control device of claim 10, wherein at least said insulator at said inlet end further comprises a mesh forming a second surface of said insulator.

15. A method of manufacturing an exhaust emission control device, comprising:
forming insulators from binder and insulation, said insulators having an inboard end, an outboard end, a first surface, and a second surface opposite said first surface;
supporting a substrate in a housing with a retention material, said housing having an inlet end and an outlet end;
placing a first one of said insulators at said inlet end such that its inboard end is supported by said substrate and said retention material; and
placing a second one of said insulators at said outlet end such that its inboard end is supported by said substrate and said retention material.

16. The method of claim 15, further comprising:
connecting a first outer shell to said inlet end over said first one of said insulators; and
connecting a second outer shell to said outlet end over said second one of said insulators.

17. The method of claim 15, wherein said housing includes an integral outer shell at said inlet end and said outlet end.

18. The method of claim 17, further comprising:
connecting said integral outer shell at said inlet end over said first one of said insulators; and
connecting said integral outer shell at said outlet end over said second one of said insulators.

19. The method of claim 15, further comprising connecting a core to said outboard end of said insulators.

20. The method of claim 15, further comprising further comprising forming said second surface of a mesh.
